(19) United States
(12) Patent Application Publication
(10) Pub. No.: US 2012/0170820 A1
(43) Pub. Date: Jul. 5, 2012

(54) METHODS AND APPARATUS FOR COMPARING 3D AND 2D IMAGE DATA

(76) Inventors: Jerome Declerck, Oxford (GB); Matthew David Kelly, Botley Oxfordshire (GB); Christian Mathers, Oxford (GB)

(21) Appl. No.: 13/303,445

(22) Filed: Nov. 23, 2011

(30) Foreign Application Priority Data
Nov. 26, 2010 (GB) 1020077.2

(51) Int. Cl. G06K 9/00

(52) U.S. Cl. 382/128

(57) ABSTRACT

In a method or apparatus of comparing two image data sets from medical imaging data of a subject, a first, three-dimensional image data set of the subject is obtained. A second, two-dimensional image data set of the subject is also obtained. The first data set is registered with the second data set. Data from the first, three-dimensional image data set is processed to determine a voxel in the first data set which corresponds to a given pixel in the second, two-dimensional image data set.

### BACKGROUND

This disclosure is directed to methods and apparatus for comparing two image data sets from medical imaging data of a subject, and embodiments for determining a point in one data set which corresponds to a point in the other.

Radionuclide-based medical images can be acquired in a number of formats, for example 3D PET and SPECT, and 2D planar. For example, a patient with metastatic cancer may undergo a series of bone scans in order to monitor disease progression or treatment response. These bone scans may be acquired as 2D planar images with the photon-emitting radionuclide 99 mTc-MDP, or as 3D SPECT images with the same radionuclide, or alternatively, as 3D PET images with the positron-emitting radionuclide 18F-NaF.

Currently, if 2D planar and 3D PET or SPECT images have been obtained for the same patient and require comparison, the identification of which point in one image (e.g., a voxel in the PET image) corresponds to a given point in the other image (e.g., a pixel in the planar image) must be performed visually by the reading physician. Given the complexity of the task this can be at best time consuming and at worst error prone.

Separately, various methodologies have been previously considered for converting a 3D medical image volume into a 2D image. These range from simply taking an individual 2D slice from the 3D image volume to generating different projections of the 3D data, e.g., a maximal intensity projection (MIP) or a virtual planar (VP) projection.

While these different methods aid the visual comparison of 3D and 2D data, they still require the reading physician to manually and visually correlate a point or region of interest (ROI) in one image with the corresponding position in the other image.

### SUMMARY

It is an object to address the above problems and provide improvements upon known devices and methods.

In a method or apparatus of comparing two image data sets from medical imaging data of a subject, a first, three-dimensional image data set of the subject is obtained. A second, two-dimensional image data set of the subject is also obtained. The first data set is registered with the second data set. Data from the first, three-dimensional image data set is processed to determine a voxel in the first data set which corresponds to a given pixel in the second, two-dimensional image data set.

### BRIEF DESCRIPTION OF THE DRAWINGS

FIG. 1 is a diagram illustrating an overview of the projection and registration steps according to an exemplary embodiment;

FIG. 2a is a diagram illustrating identification of a point in an image according to an exemplary embodiment;

FIG. 2b is a diagram illustrating identification of a point in another image according to an exemplary embodiment;

FIG. 3 is a diagram illustrating generation of a virtual planar projection according to an exemplary embodiment;

FIG. 4 is a diagram illustrating an overview of the projection and registration steps according to a more specific exemplary embodiment;

FIG. 5 is a diagram illustrating identification of a point in an image according to the embodiment of FIG. 4; and

FIG. 6 is a diagram illustrating an apparatus according to an embodiment.

### DESCRIPTION OF THE PREFERRED EMBODIMENTS

For the purposes of promoting an understanding of the principles of the invention, reference will now be made to preferred exemplary embodiments/best mode illustrated in the drawings and specific language will be used to describe the same. It will nevertheless be understood that no limitation of the scope of the invention is thereby intended, and such alterations and further modifications in the illustrated embodiments and such further applications of the principles of the invention as illustrated as would normally occur to one skilled in the art to which the invention relates are included.

In general terms, one first exemplary embodiment can provide a method of comparing two image data sets from medical imaging data of a subject, comprising the steps of: obtaining a first, three-dimensional image data set of the subject; obtaining a second, two-dimensional image data set of the subject; registering the first data set with the second data set; and processing data from the first, three-dimensional image data set to determine a voxel in the first data set which corresponds to a given pixel in the second, two-dimensional image data set.

This allows the automatic identification of which point in a 3D image corresponds to a given point in the 2D image being compared, thus avoiding errors which could be made by the reading physician alone performing a visual comparison.

Preferably, the step of registering further comprises: generating from the first, three-dimensional image data set a two-dimensional image; and registering the two-dimensional image from the first data set with a two-dimensional image derived from the second, two-dimensional image data set.

Suitably, the two-dimensional image generated from the first, three-dimensional image data set is a two-dimensional projection image. In one exemplary embodiment, the projection image is a virtual planar projection.

Use of the virtual planar projection with the novel methods herein described allows a superior, and qualitative, comparison of the two images. As attenuation set of the subject; obtain a second, two-dimensional image data set of the subject; register the first data set with the second data set; and process data from the first, three-dimensional image data set to determine a voxel in the first data set which corresponds to a given pixel in the second, two-dimensional image data set; and a display device adapted to display the determined voxel with images from the first and second data sets.

A third exemplary embodiment can provide a method of dosimetry analysis, comprising the steps of: implementing a method according to any of the above described aspects and embodiments; and propagating a segment, from a segmentation of the first, three-dimensional image data set, to the second, two-dimensional image data set, said segment comprising the determined voxel which corresponds to the given pixel.

The above aspects and embodiments may be combined to provide further aspects and embodiments.

The embodiments will now be described by way of example with reference to the accompanying drawings, and when the following terms are used herein, the accompanying definitions can be applied:

CT Computed Tomography

MDP Methyl Diphosphonate

MIP Maximal Intensity Projection

NaF 18F Sodium Flouride

PET Positron Emission Tomography

ROI Region of Interest

SPECT Single Photon Emission Computed Tomography

VP Virtual Planar References

Exemplary embodiments can facilitate the comparison of 2D (such as 2D planar) and 3D (such as PET or SPECT) images by automatically identifying which point in one image (e.g., a voxel in the PET image) corresponds to a given point in the other image (e.g., a pixel in the planar image). This is done in exemplary embodiments by combining a specific projection method for 3D data to 2D, i.e., a virtual planar (VP) projection, with registration of the generated and original 2D planar images, and a method for identifying the most likely depth of the point of interest in the 3D image (when comparison coming from the 2D image).

The result from the algorithm can be displayed as correlated crosshairs for example, or by auto navigating to the corresponding pixel/voxel in one image based on the click point in the other.

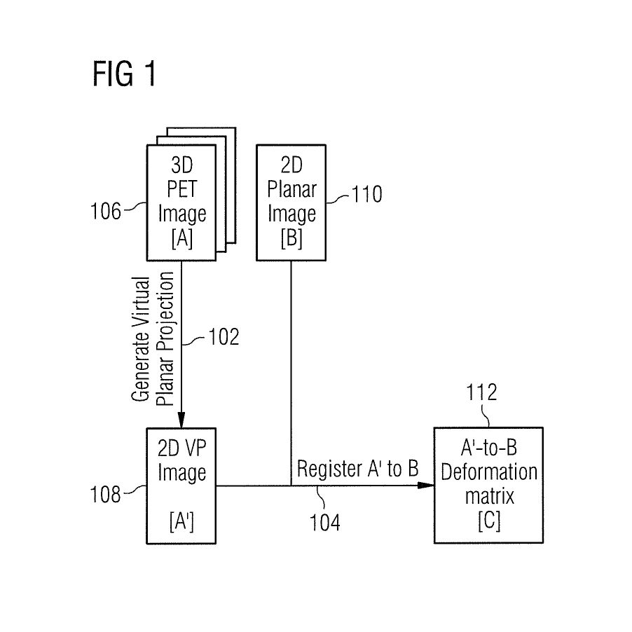

An overview of the projection and registration steps is shown in FIG. 1. This shows alignment of a 3D PET image A (106) with a 2D planar image B (110) via the virtual planar projection (10) of the 3D PET A to create a 2D virtual planar image A′ (108), and 2D registration (104) between the virtual planar image A′ and the original 2D planar image B being evaluated. The registration produces an A′-to-B deformation matrix C (112).

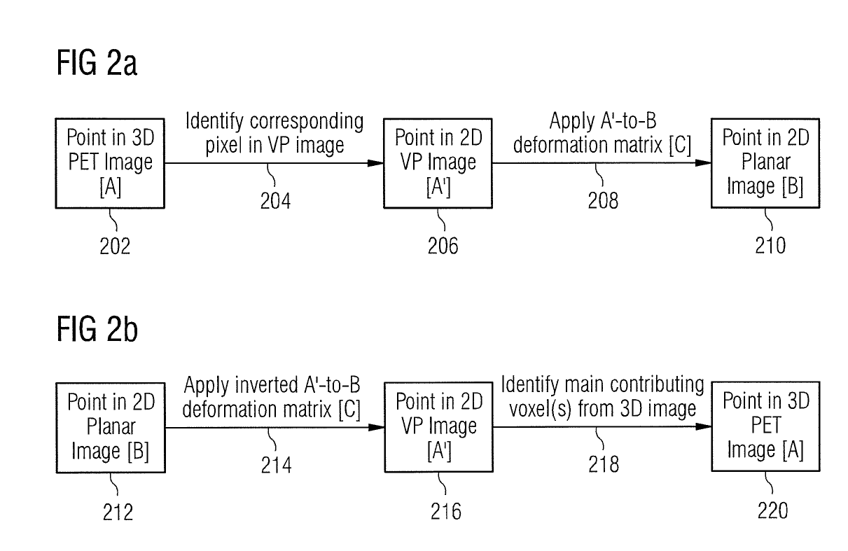

Given a generated virtual planar image A′ and deformation matrix C, the identification of the corresponding point in a 2D planar image from a selected point in a 3D tomographic image can be performed as described in FIG. 2a.

From the point in the 3D PET image A (202), identify (204) the corresponding pixel in the generated VP image A′ (206), and then apply the A′-to-B deformation matrix C (208) to find the corresponding point in the 2D planar image B (210).

The reverse process of identifying the corresponding point in a 3D tomographic image from a selected point in a 2D planar image is described in FIG. 2b.

From the point in the 2D planar image B (212), apply the inverted N-to-B deformation matrix C (214) to find the corresponding point in the generated VP image A′ (216), then identify (218) the main contributing voxel from the 3D image A (220) corresponding to the pixel in the generated VP image A′ (216).

More details of the individual steps are shown in the following sections.

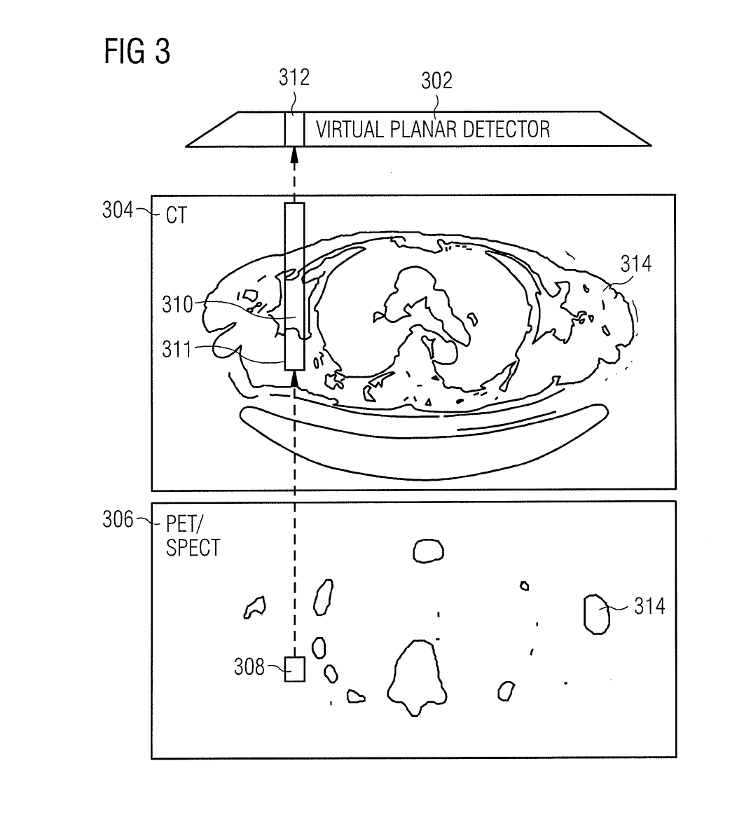

VP projections are generally generated by simulating planar acquisitions from reconstructed 3D attenuation corrected images, such as corrected PET and SPECT images, and have been described previously for SPECT (Bailey et al., 2008 “Generation of planar images from lung ventilation/perfusion SPECT” 22(5) 437-445). FIG. 3 illustrates the principles, with images of a subject (314) for example in CT and PET/SPECT. PET/SPECT voxel intensities in the lower panel are attenuated using the voxel intensities from the co-registered CT volume (middle panel) that lie on the path between the PET voxel location and the virtual planar detector (top of figure)

In brief, for each voxel (308) in a 3D image (PET/SPECT 306), the path (310) between its corresponding location (311) in the CT image (304) used for attenuation correction, and the Virtual Planar “detector” (302) is identified.

The attenuation due to those CT voxels lying along this path 310 is then calculated, based on Hounsfield unit to attenuation coefficient conversion used in PET image reconstruction. The attenuated PET activity from the PET voxel is then recorded in the corresponding bin (312) in the Virtual Planar detector. Once this process has been repeated for all PET voxels in the 3D PET or SPECT image, the sum of activities recorded for each bin in the Virtual Planar detector is assigned to the corresponding pixel in the Virtual Planar image.

A 3D PET image could be converted to a 2D image by simply summing up the voxel values along a given projection (or alternatively taking the maximum intensity value along a projection to give a MIP). However, the benefit of generating a virtual planar projection and using this for registration with a planar scan is that the virtual planar projection method effectively simulates the physical process of a planar acquisition (i.e., it accounts for the attenuation of the photons emitted by the radiotracer as they travel through the body to the detector using the anatomical information from the CT scan). This in turn means that the virtual planar image will be visually more similar to a directly acquired planar image, than would a simpler projection method (such as a summed image or a MIP). For example, anterior and posterior images of a subject will be different in 2D planar, and in virtual planar images, whereas they would typically be identical in summation or MIP images.

A result of this increased visual similarity is likely an improved performance of any registration algorithm used to align to the 2D images (i.e., virtual planar and directly acquired planar scan).

The two 2D planar images, the original planar and the virtual planar, can then be registered to one another using any available registration algorithm, either rigid, affine or non-rigid, for example, using maximization of mutual information or other similar image similarity metric. The registration typically produces a deformation matrix. One requirement of this registration may be that the resultant deformation matrix should be invertible—this allows a simple completion of the reverse pixel identification shown in FIG. 2b.

The next step is identification of the main contributing voxel from the 3D tomograph to a given 2D Virtual Planar pixel. Identification can be performed in a number of ways. For example, a simple approach would be to identify, from all tomograph voxels that contribute to a given planar pixel, the voxel that contributes the highest individual value to the planar pixel following attenuation of the original voxel value based on the CT.

An alternative approach that may be less sensitive to noise would be to plot the attenuated voxel values of all tomograph voxels that contribute to a given planar pixel along the projection path, smooth this plot (e.g., using a Gaussian filter or median filter) and then identify the tomograph voxel with the highest value in this smoothed plot.

Conversely, identification of the 2D virtual planar pixel that corresponds to a given voxel in the 3D tomographic image can be determined simply from the projection paths used to generate the virtual planar, i.e., each tomograph voxel contributes directly to a virtual planar image pixel as part of the generation of the virtual planar image.

In a clinical example, consider a clinician reviewing a recently acquired 18F-NaF PET scan for a patient who had previously received a 99 mTc-MDP planar bone scan. On an axial slice of the PET scan, the clinician notices suspicious uptake and wants to compare it with the same region on the prior planar scan. The system of the exemplary embodiments herein can aid the clinician by identifying the corresponding region as described in the following steps.

Step 1: Alignment of 18F-NaF PET to 99 mTc-MDP planar:

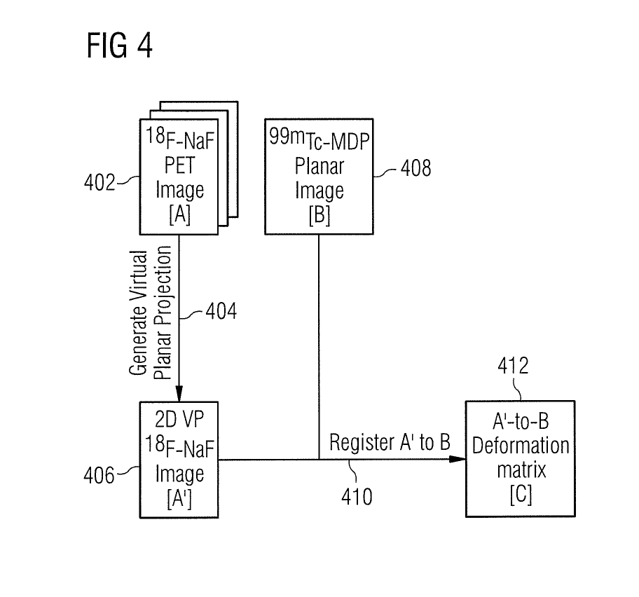

With reference to FIG. 4 (similar to FIG. 2a), the system first generates (404) a virtual planar projection A′ (406) of the 3D 18F-NaF PET image A (402) and then registers (410) the resulting 2D 18F-NaF virtual planar image A′ to the 2D 99 mTc-MDP planar bone scan B (408). The resultant deformation matrix C (412) is used in Step 2 to compute correspondence between a 3D 18F-NaF PET image voxel and a 2D 99 mTc-MDP planar image pixel.

Step 2: Correspondence of 18F-NaF PET voxel to 99 mTc-MDP planar pixel:

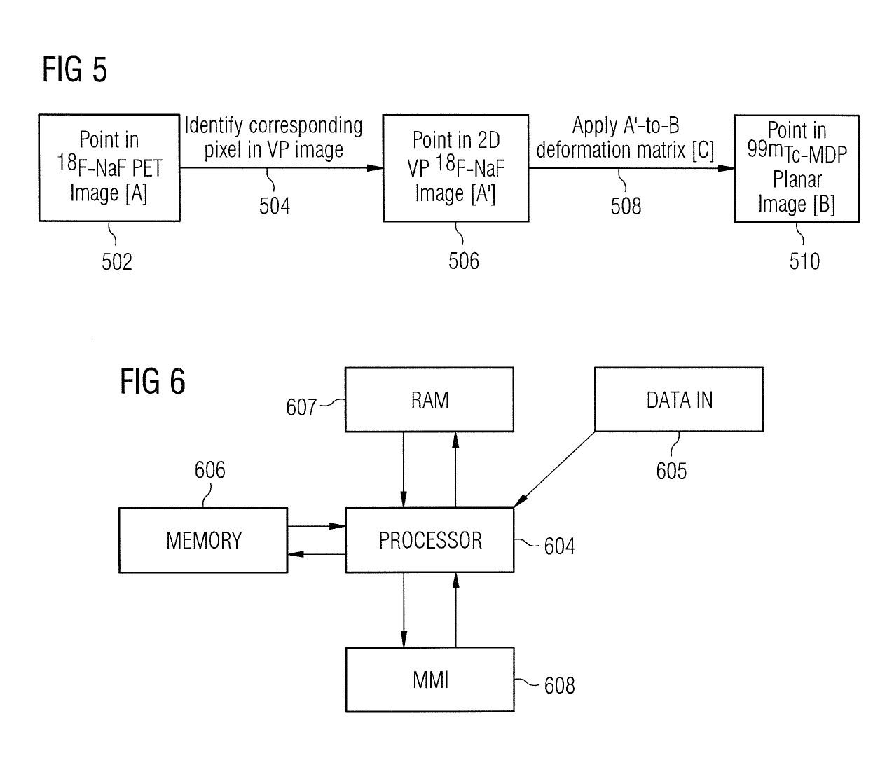

With reference to FIG. 5, the system first identifies (504) the pixel in the 2D virtual planar 18F-NaF image A′ (506) to which the intensity in the user-selected voxel (representing the suspicious uptake) in the 3D 18F-NaF PET image A (502) contributed. The corresponding pixel in the 2D 99 mTc-MDP planar bone scan B (510) is then identified using the deformation matrix computed in Step 1.

In an opposite example, the user may be reviewing the prior planar scan, and wish to identify whether a suspicious feature is actually in a problematic area, or in an area of the subject which would suggest the feature is benign. The user would then use the system in the opposite way, in the general way shown in FIG. 2b, and using Step 1 above. For Step 2 this time, the user selects a pixel in the 99 mTc-MDP planar bone scan B (510), the same (but inverted) matrix C is applied to find a point in the VP image, and one of the methods described above is used to identify the main contributing voxel from the 18F-NaF PET image A (502). The user can then view that voxel in the 3D image, and see whether the contribution from the 3D image data for that suspicious pixel in the 2D 99 mTc-MDP planar bone scan B is in a problematic anatomical region (perhaps a lung area potentially containing lesions), or in an irrelevant one.

Alternative ways in which exemplary embodiments herein may be realized are as follows.

In the planar to virtual planar registration step, any alternative rigid or non-rigid registration algorithms may be used.

In the step of identifying the main contributing voxel from the 3D tomograph to a 2D virtual planar pixel, different filters may be used to reduce the impact of noise on the identification of the appropriate voxel. Alternative signal processing methods could be performed on the plot of the attenuated voxel values of all tomograph voxels that contribute to a given planar pixel along the projection path, in order to reduce the effect of noise.

If the 3D tomography is labelled using an independent method (each bone is given its exact name: for instance, each vertebra is labelled T1, T2, etc.), the labelling can be propagated to the planar image, for easier reporting.

Organ or lesion segmentations from the 3D tomographic image could be propagated to related planar images (via virtual planar projection and virtual planar to planar registration) to facilitate the comparison of radiotracer uptake across acquisitions.

This methodology has a potential application to a dosimetry analysis for radionuclide therapy. With this type of dosimetry analysis, a combination of 3D (e.g., SPECT) and 2D (e.g., planar) scans may be acquired to measure the uptake of a photon-emitting radionuclide therapy agent in various body regions over a period of time (e.g., hours to days). The analysis of these uptake measurements will require the identification of equivalent regions in both the 3D and 2D images (e.g., uptake in healthy organs such as the liver or uptake in the lesion). To achieve this, segmentations made on the 3D image (e.g., a liver segmentation made on a CT image registered to the SPECT image) will need to be propagated to the 2D image. This can be done using the techniques described above for identifying which pixel in a 2D image corresponds to a given voxel in the 3D image.

Referring to FIG. 6, the above exemplary embodiments may be conveniently realized as a computer system suitably programmed with instructions for carrying out the steps of the methods according to the various embodiments.

For example, a central processing unit 604 is able to receive data representative of medical scans via a port 605 which could be a reader for portable data storage media (e.g. CD-ROM); a direct link with an apparatus such as a medical scanner (not shown) or a connection to a network. For example, in an exemplary embodiment, the processor performs such steps as generating from a first set of the imaging data an intensity projection line along a specified axis of an image volume of the data, converting the projection line to a monogenic signal and extracting phase information from the signal, calculating a function of the phase information to produce processed phase information, and using the processed phase information to organize the feature of interest in the first data set.

Software applications loaded on memory 606 are executed to process the image data in random access memory 607.

A Man—Machine interface 608 typically includes a keyboard/mouse/screen combination (which allows user input such as initiation of applications) and a screen on which the results of executing the applications are displayed.

It will be appreciated by those skilled in the art that the invention has been described by way of example only, and that a variety of alternative approaches may be adopted without departing from the scope of the invention, as defined by the appended claims.

Although preferred exemplary embodiments are shown and described in detail in the drawings and in the preceding specification, they should be viewed as purely exemplary and not as limiting the invention. It is noted that only preferred exemplary embodiments are shown and described, and all variations and modifications that presently or in the future lie within the protective scope of the invention should be protected.

We claim as our invention:

1. A method of comparing two image data sets from medical imaging data of a subject, comprising the steps of:
obtaining a first, three-dimensional image data set of the subject;
obtaining a second, two-dimensional image data set of the subject;
registering the first data set with the second data set; and
processing data from the first, three-dimensional image data set to determine a voxel in the first data set which corresponds to a given pixel in the second, two-dimensional image data set.

2. The method according to claim 1 wherein the step of registering further comprises:
generating from the first, three-dimensional image data set a two-dimensional image; and
registering the two-dimensional image from the first data set with a two-dimensional image derived from the second, two-dimensional image data set.

3. The method according to claim 2 wherein the two-dimensional image generated from the first, three-dimensional image data set is a two-dimensional projection image.

4. The method according to claim 3 wherein the projection image is a virtual planar projection.

5. The method according to claim 2 wherein the step of processing data from the first data set to determine a voxel comprises identifying the voxel from the first, three-dimensional image data set which provides a greatest contribution to generating a pixel in the generated two-dimensional image, said pixel corresponding to the given pixel in the second, two-dimensional image data set.

6. The method according to claim 5 wherein the step of identifying the voxel comprises:
determining a value of a given variable for voxels along a projection line in the three-dimensional image data set, said projection line being associated with said pixel in the generated two-dimensional image; and
identifying from the voxels along the projection line the voxel with a highest value for the given variable.

7. The method according to claim 6 further comprising, prior to identifying the voxel with the highest value, filtering the variable values for the voxels.

8. The method according to claim 6 wherein the given variable comprises an attenuated PET activity.

9. The method according to claim 1 further comprising processing data from the first, three-dimensional image data set to determine a pixel in the second data set which corresponds to a given voxel in the first, three-dimensional image data set.

10. The method according to claim 9 wherein the step of processing said data to determine said pixel comprises determining the pixel in the second data set associated with a projection path through the three-dimensional image data set which includes the given voxel.

11. An apparatus for comparing two image data sets from medical imaging data of a subject, comprising:
a processor adapted to obtain a first, three-dimensional image data set of the subject, to obtain a second, two-dimensional image data set of the subject, to register the first data set with the second data set, and to process data from the first, three-dimensional image data set to determine a voxel in the first data set which corresponds to a given pixel in the second, two-dimensional image data set; and
a display device adapted to display the determined voxel with images from the first and the second data sets.

12. A method of dosimetry analysis, comprising the steps of:
comparing two image data sets from medical imaging data of the subject by:
obtaining a first, three-dimensional image data set of the subject,
obtaining a second, two-dimensional image data set of the subject, and
registering a first data set with the second data set;
processing data from the first, three-dimensional image data set to determine a voxel in the first data set which corresponds to a given pixel in the second, two-dimensional image data set; and
propagating a segment from a segmentation of the first, three-dimensional image data set to the second, two-dimensional image data set, said segment comprising the determined voxel which corresponds to the given pixel.

13. A tangible, non-transitory computer readable medium comprising a computer program for comparing two image data sets from medical imaging data of a subject, said program performing the steps of:
obtaining a first, three-dimensional image data set of the subject;
obtaining a second, two-dimensional image data set of the subject;
registering the first data set with the second data set; and
processing data from the first, three-dimensional image data set to determine a voxel in the first data set which corresponds to a given pixel in the second, two-dimensional image data set.
